(19) United States
(12) Patent Application Publication
(10) Pub. No.: US 2024/0322218 A1
(43) Pub. Date: Sep. 26, 2024

(54) DIAMONDOID SALTS AND RELATED COMPOSITIONS

(71) Applicants: Wisconsin Alumni Research Foundation, Madison, WI (US); Justus-Liebig-Universitaet Giessen, Giessen (DE); The Board of Trustees of the Leland Stanford Junior University, Stanford, CA (US)

(72) Inventors: Matthew Gebbie, Madison, WI (US); Beichen Liu, Madison, WI (US); John McAlpine, Madison, WI (US); Ryan Cashen, Madison, WI (US); Peter R. Schreiner, Wettenberg (DE); Boryslav O. Tkachenko, Giessen (DE); Nicholas Melosh, Menlo Park, CA (US); Jeremy Dahl, El Cerrito, CA (US); Robert Carlson, Petaluma, CA (US)

(21) Appl. No.: 18/578,298

(22) PCT Filed: Jul. 11, 2022
(86) PCT No.: PCT/US2022/073592

§ 371 Date: Jan. 10, 2024

Related U.S. Application Data
(60) Provisional application No. 63/220,673, filed on Jul. 12, 2021.

(51) Int. Cl. H01M 10/0525; C25B 3/26; H01M 10/0567; H01M 10/0568

(52) U.S. Cl. CPC H01M 10/0525; C25B 3/26; H01M 10/0567; H01M 10/0568; H01M 2300/0025

(57) ABSTRACT

Provided are diamondoid salts, electrolytes comprising the diamondoid salts, and electrochemical devices incorporating the diamondoid salts or electrolytes. In embodiments, an electrolyte for an electrochemical device comprises a metallic salt and a diamondoid salt, the diamondoid salt comprising a diamondoid-functionalized cationic core and a counter anion, the diamondoid-functionalized cationic core comprising a cationic core and a diamondoid group covalently bound to the cationic core.

### CROSS-REFERENCE TO RELATED APPLICATIONS

The present application claims priority to U.S. provisional patent application No. 63/220,673 that was filed Jul. 12, 2021, the entire contents of which are incorporated herein by reference.

### BACKGROUND

Solvent decomposition under high potentials is a key process leading to the failure of electrochemical devices, including batteries and electrolyzers. Additives to stabilize high potential electrodes are critically needed to enable next-generation battery electrodes, like lithium metal anodes or transition metal cathodes. Anodic stabilization approaches have relied on slowing parasitic decomposition via the formation of LiF layers from fluorinated electrolyte species, but this strategy is ineffective as electrolyte volumes are decreasing and electrode voltages are increasing. The lack of high voltage electrode stabilizing additives, including cathodic stabilizing additives, is a major barrier for continued improvement of lithium-ion batteries and prevents the adoption of several emerging battery chemistries.

### SUMMARY

Provided are diamondoid salts, electrolytes comprising the diamondoid salts, and electrochemical devices incorporating the diamondoid salts or electrolytes. Related methods are also provided. The diamondoid salts comprise a diamondoid-functionalized cationic core and a counter anion. At least some embodiments of the present diamondoid salts are characterized by an ability of the diamondoid-functionalized cationic cores to assemble at a charged interface forming a protective layer that inhibits the passage of certain components (e.g., solvent molecules and/or ions) therethrough, while allowing the passage of other components (redox species of interest). Such a selectively-permeable layer protects the interface from exposure to these solvent molecules/other ions, which otherwise would reach the interface and decompose. However, the present disclosure is not limited to interfacial stabilization via a particular mechanism. That is, stabilization as evidenced by solvent protection achieved by assembly of the diamondoid-functionalized cationic cores at an interface is merely one illustrative advantage and mechanism of interfacial stabilization.

Another illustrative advantage exhibited by at least some embodiments of the present diamondoid salts relates to increased metal ion (e.g., lithium ion) mobility in mixtures of the diamondoid salt with a metallic salt (e.g., lithium salt). Specifically, when mixed with metallic salts, at least some embodiments of the present diamondoid salts are characterized by an ability to suppress the coordination between metal ions and counter anions, leading to enhanced metal ion mobility in the mixture.

An embodiment 1 is an electrolyte for an electrochemical device, the electrolyte comprising a metallic salt and a diamondoid salt, the diamondoid salt comprising a diamondoid-functionalized cationic core and a counter anion, the diamondoid-functionalized cationic core comprising a cationic core and a diamondoid group covalently bound to the cationic core.

An embodiment 2 is the electrolyte according to embodiment 1, wherein the cationic core is selected from a nitrogen-containing heterocyclic moiety, a phosphonium moiety, an ammonium moiety, and a sulfonium moiety.

An embodiment 3 is the electrolyte according to embodiment 2, wherein the nitrogen-containing heterocyclic moiety comprises a 5-membered ring.

An embodiment 4 is the electrolyte according to embodiment 3, wherein the 5-membered ring is selected from a group consisting of pyrrolidine, imidazole, benzimidazole, pyrazole, oxathiole, thiazole, and triazole.

An embodiment 5 is the electrolyte according to embodiment 2, wherein the nitrogen-containing heterocyclic moiety comprises a 6-membered ring.

An embodiment 6 is the electrolyte according to embodiment 5, wherein the 6-membered ring is selected from a group consisting of piperidine, pyridine, morpholine, and 1,5-diazabicyclo[4.3.0]non-5-en.

An embodiment 7 is the electrolyte of any of embodiments 1-6, wherein any other position on the cationic core not occupied by the diamondoid group is an R group and each R group is independently selected from a group consisting of hydrogen: an unsubstituted or substituted alkyl group: an unsubstituted or substituted aryl group: an alkoxy group (—OR′) wherein R′ is hydrogen or an unsubstituted alkyl group: an amine group (—NR″₃) wherein each R″ is independently selected from hydrogen and an unsubstituted alkyl group; and a second diamondoid group.

An embodiment 8 is the electrolyte of embodiment 1, wherein the cationic core is selected from a nitrogen-containing heterocyclic moiety and wherein any other position on the cationic core not occupied by the diamondoid group is an R group and each R group is independently selected from a group consisting of hydrogen: an unsubstituted or substituted alkyl group: an unsubstituted or substituted aryl group: an alkoxy group (—OR′) wherein R′ is hydrogen or an unsubstituted alkyl group: an amine group (—NR″₃) wherein each R″ is independently selected from hydrogen and an unsubstituted alkyl group; and a second diamondoid group.

An embodiment 9 is the electrolyte of embodiment 8, wherein the nitrogen-containing heterocyclic moiety comprises a 5-membered ring.

An embodiment 10 is the electrolyte of embodiment 9, wherein the 5-membered ring is imidazole.

An embodiment 11 is the electrolyte of embodiment 1, wherein the diamondoid-functionalized cationic core has Formula I

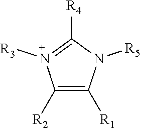

wherein at least one of R₁, R₂, R₃, R₄, and R₅ is the diamondoid group and the remaining of R₁, R₂, R₃, R₄, and R₅ are independently selected from a group consisting of: a second diamondoid group: hydrogen: an unsubstituted or substituted alkyl group: an unsubstituted or substituted aryl group: an alkoxy group (—OR′) wherein R′ is hydrogen or an unsubstituted alkyl group: an amine group (—NR″₃) wherein each R″ is independently selected from hydrogen and an unsubstituted alkyl group; and R₁ and R₂ joining to form a fused benzene ring.

An embodiment 12 is the electrolyte of embodiment 11 wherein the diamondoid-functionalized cationic core has Formula IA

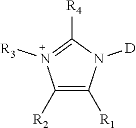

wherein D is the diamondoid group and R₁, R₂, R₃, and R₄ are independently selected from a group consisting of: a second diamondoid group: hydrogen; an unsubstituted or substituted alkyl group: an unsubstituted or substituted aryl group; an alkoxy group (—OR′) wherein R′ is hydrogen or an unsubstituted alkyl group; and an amine group (—NR″₃) wherein each R″ is independently selected from hydrogen and an unsubstituted alkyl group.

An embodiment 13 is the electrolyte of embodiment 12, wherein R₁, R₂, R₃, and R₄ are independently selected from a group consisting of: a second diamondoid group; hydrogen: an unsubstituted alkyl group; and a substituted alkyl group.

An embodiment 14 is the electrolyte of embodiment 1, wherein the diamondoid-functionalized cationic core is 3-(adamantan-1-yl)-1-methylimidazolium; 1,3-bis(adamantan-1-yl)imidazolium: 3-(diamantan-4-yl)-1-methylimidazolium; or 3-(3,5-dimethyladamantan-1-yl)-1-methylimidazolium.

An embodiment 15 is the electrolyte of embodiment 1, wherein the diamondoid-functionalized cationic core is 3-(adamantan-1-yl)-1-methylimidazolium.

An embodiment 16 is the electrolyte of any of embodiments 1-13, wherein the diamondoid salt has 1 or 2 diamondoid groups covalently bound to the cationic core.

An embodiment 17 is the electrolyte of any of embodiments 1-13, wherein the diamondoid salt is non-symmetric.

An embodiment 18 is the electrolyte of any of embodiments 1-13 or 16 or 17, wherein the diamondoid group is other than adamantane.

An embodiment 19 is the electrolyte of any of embodiments 1-18, wherein the metallic salt is lithium salt.

An embodiment 20 is an electrochemical device comprising an electrode, a counter electrode in electrical communication with the electrode, and the electrolyte of any of embodiments 1-19 in contact with the electrode, the counter electrode, or both.

An embodiment 21 is the electrochemical device of embodiment 20, wherein the electrochemical device is a lithium-ion battery.

An embodiment 22 is the electrochemical device of embodiment 20, wherein the electrochemical device is a CO₂ electrolyzer.

An embodiment 23 is a method of operating the electrochemical device of any of embodiments 20-22, the method comprising applying an electrical load or a voltage between the electrode and the counter electrode.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1E show illustrative diamondoid-functionalized cationic cores based on 5-membered nitrogen-containing heterocyclic moieties.

FIGS. 2A-2D show illustrative diamondoid-functionalized cationic cores based on 6-membered nitrogen-containing heterocyclic moieties.

FIGS. 3A-3C show illustrative diamondoid-functionalized cationic cores based on phosphonium, ammonium, and a sulfonium moieties.

FIG. 4 is a schematic illustration of an electrochemical cell comprising an illustrative diamondoid salt therein.

FIG. 5 is a schematic illustration of the interfacial stabilization effect exhibited by an illustrative diamondoid salt.

FIG. 6 shows the results of electrolysis experiments using an electrolyte comprising an illustrative diamondoid salt and a comparative imidazolium salt.

FIG. 7 shows the results of electrolysis experiments using an electrolyte comprising another illustrative diamondoid salt and a comparative imidazolium salt.

FIG. 8 shows the general synthesis of an illustrative diamondoid salt. In this figure, “Hal” refers to a halogen: “Alk” refers to an alkyl group: “Me” refers to methyl; and “A” refers to an anion.

FIG. 9A shows the three main attractive forces in mixtures of an ionic liquid lithium. While there is limited control over the cation-anion and lithium-anion attractions, the organic nature of ionic liquid cations allows for much modulation of the substituents. Through the introduction of substituents that drive molecular assembly new nanostructures can be investigated. FIG. 9B shows examples of different chemical constituents that could be attached to a cation. Moving from left to right, intermolecular forces favoring molecular contact increases. FIG. 9C shows four diamondoid functionalized cationic cores (AdImMe, AdImAd, Me2AdImMe, and DiamImMe) which leverage the benefits of energetically favorable self-assembly. The trifluorosulfonylimide (TFSI) anion is also shown. The lack of conformational entropy penalty associated with formation of contact pairs increases substituent-substituent interactions.

FIG. 10A shows a phase diagram of [AdImMe][TFSI] and [Li][TFSI]. The gray area shows where data becomes difficult to obtain due to poor mixing between [AdImMe][TFSI] and [Li][TFSI] at high [Li][TFSI] concentration, resulting in high variability in mixture compositions during preparation. FIG. 10B shows a phase diagram of [DiamImMe][TFSI] and [Li][TFSI].

FIGS. 11A and 11C show Raman spectra of the pure organic salts (0 mol % Li⁺) for [C₄MIm][TFSI] and [AdImMe][TFSI], respectively, while FIGS. 11B and 11D show the Raman spectra of the salts with 50 mol % Li⁺, respectively. As shown in FIGS. 11A and 11B, increasing the concentration of [Li][TFSI] in [C₄MIm][TFSI] leads to a shift to higher Raman energies indicative of TFSI coordinating to lithium ions. However, FIGS. 11C and 11D show that no such behavior is observed for [AdImMe][TFSI]. The changes in FIGS. 11C and 11D are due to the reduced concentration of AdImMe and not from the increased concentration of Li. Black circles are the Raman data, solid lines are the cumulative fit of the data, and the dashed lines are components to the overall fit.

FIG. 12 shows a comparison of the static ⁷Li NMR spectra of neat [Li][TFSI] and 0.1 mole fraction [Li][TFSI] mixtures with [AdImAd][TFSI], [DiamImMe][TFSI], or [AdImMe][TFSI]. The mixture containing [AdImMe][TFSI] and 0.1 mole fraction [Li][TFSI] exhibits the lowest chemical shift anisotropy and thus, has the highest lithium mobility. All peaks are normalized versus the maximum intensity observed in each measurement.

### DETAILED DESCRIPTION

Provided are diamondoid salts, electrolytes comprising the diamondoid salts, and electrochemical devices incorporating the diamondoid salts or electrolytes. Related methods are also provided.

In embodiments, a diamondoid salt comprises a cationic core and at least one diamondoid (D) group covalently bound to the cationic core, i.e., a diamondoid-functionalized cationic core. The cationic core is a molecular moiety capable of carrying a positive charge. In embodiments, the cationic core is a nitrogen-containing heterocyclic moiety. The nitrogen-containing heterocyclic moiety may comprise a 5-membered ring. In embodiments, the 5-membered ring comprises a single heteroatom (the nitrogen), two heteroatoms (the nitrogen and another heteroatom, e.g., oxygen or another nitrogen), or three heteroatoms (the nitrogen and two other heteroatoms, e.g., two other nitrogens). The nitrogen-containing heterocyclic moiety may comprise a 6-membered ring. In embodiments, the 6-membered ring comprises a single heteroatom (the nitrogen) or two heteroatoms (the nitrogen and another heteroatom, e.g., oxygen or another nitrogen). The 5- or 6-membered ring may be fused to a cyclic group, which may be aromatic, e.g., benzene. The nitrogen-containing heterocyclic moiety may be saturated, partially unsaturated, or unsaturated.

Illustrative nitrogen-containing heterocyclic moieties which comprise a 5-membered ring include pyrrolidine, imidazole, benzimidazole, pyrazole, oxathiole, thiazole, and triazole. Illustrative nitrogen-containing heterocyclic moieties comprising a 6-membered ring include piperidine, pyridine, morpholine, and 1,5-diazabicyclo[4.3.0]non-5-en.

In other embodiments, the cationic core may be a phosphonium, ammonium, or a sulfonium moiety.

As noted above, at least one diamondoid group is covalently bound to the cationic core of the diamondoid salt, thereby providing a diamondoid-functionalized cationic core. This includes having 1, 2, 3, 4, 5, 6, etc. diamondoid groups covalently bound to the cationic core. Each diamondoid group may assume any position on the cationic core, e.g., any position on a nitrogen-containing heterocyclic moiety. Any other position on the cationic core not occupied by a diamondoid group may be represented by a covalently bound R group.

Each R may be independently selected from hydrogen, an alkyl group, an aryl group, an alkoxy group (—OR′), and an amine group (—NR″₃).

The alkyl group may have from 1 to 20 carbons. This includes from 1 to 18 carbons, from 1 to 16 carbons, from 1 to 14 carbons, etc. The alkyl group may be a linear alkyl group. The alkyl group may be unsubstituted, by which it is meant containing no heteroatoms, or substituted. By substituted, it is meant an unsubstituted alkyl group in which one or more bonds to a carbon(s) or hydrogen(s) are replaced by a bond to non-hydrogen and non-carbon atoms. Non-hydrogen and non-carbon atoms include, e.g., a halogen atom such as F, Cl, Br, and I: an oxygen atom, including an oxygen atom in groups such as hydroxyl, alkoxy, aryloxy, carbonyl, carboxyl, and ester groups: a nitrogen atom, including a nitrogen atom in groups such as amines, amides, alkylamines, arylamines, and alkylarylamines, and nitriles; and a sulfur atom.

The aryl group may be monocyclic having one aromatic ring, e.g., benzene, phenyl. The aryl group may be unsubstituted or substituted as described above with respect to the alkyl group, although substituted aryl groups also encompass aryl groups in which a bond to a hydrogen(s) is replaced by a bond to an unsubstituted or substituted alkyl group as described above.

In the alkoxy group (—OR′) and the amine group (—NR″₃), the “—” denotes the covalent bond to the cationic core and each R′ and R″ is independently selected from hydrogen and an unsubstituted alkyl group as defined above.

The terms “diamondoid,” “diamondoid group,” and the like refer to hydrocarbon cage molecules in which at least some (or all) of the carbons are bound as in diamond. The smallest diamondoid is adamantane (C₁₀H₁₆), in which the 10 carbons are bound together forming a cyclic tetrahedral structure as in diamond. Thus, “diamondoid” refers to adamantane as well as derivatives of adamantane. Other illustrative diamondoids include diamantane, triamantane, tetramantane, pentamantane, cyclohexamantane, heptamantane, octamantane, nonamantane, decamantane, undecamantane, alkyl pentamantane, 3-methyl-pentamantane, 3,5-dimethyladamantane, etc. The diamondoids may be substituted, e.g., with alkyl groups, carboxylic acid groups, hydroxyl groups, or both. Some diamondoids, e.g., adamantane, may be synthesized using known techniques. Others may be extracted from petroleum using known techniques. Diamondoid synthetic techniques and petroleum extraction techniques described in Dahl, J. E., et al., “Isolation and structure of higher diamondoids, nanometer-sized diamond molecules.” Science 299.5603 (2003): 96-99 (hereby incorporated by reference in its entirety) and the references cited therein may be used.

The present diamondoid salts may comprise any type of diamondoid as the covalently bound diamondoid group. As noted above, various numbers of diamondoid groups in the diamondoid salt may be used. However, in embodiments, at least one of the diamondoid groups is a diamondoid other than adamantane. In such embodiments, although adamantane may be covalently bound to the cationic core, at least one other diamondoid group other than adamantane is covalently bound to the cationic core.

The present diamondoid salts may be characterized by their symmetry, with respect to the type and number of the diamondoid groups covalently bound to the cationic core. Symmetric diamondoid salts refer to salts having an even number of the same type of diamondoid groups (e.g., two adamantanes), which are generally covalently bound to the cationic core in symmetrical positions. Non-symmetric diamondoid salts refer to all other salts including asymmetric diamondoid salts. Asymmetric diamondoid salts encompass salts having an odd number of diamondoid groups of the same type (e.g., a single diamondoid group) as well as salts having two different types of diamondoid groups.

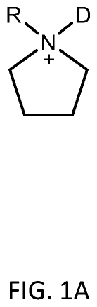

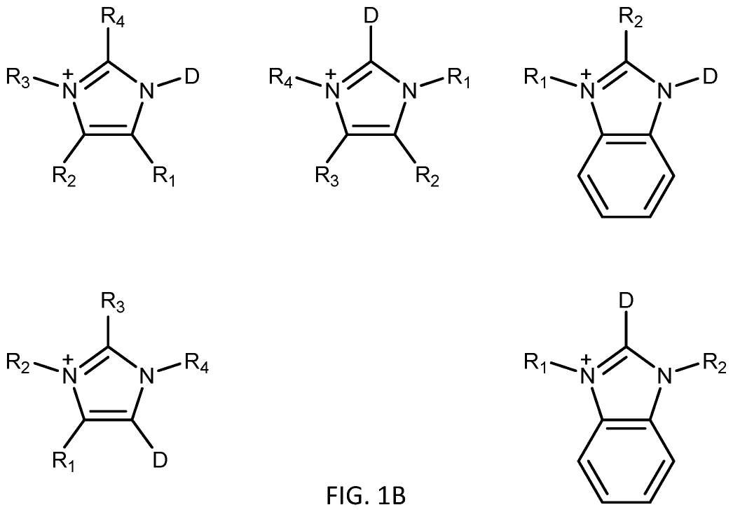

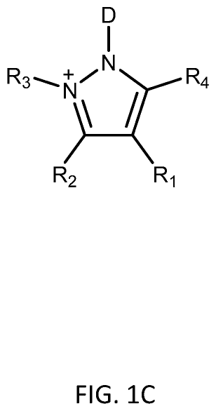

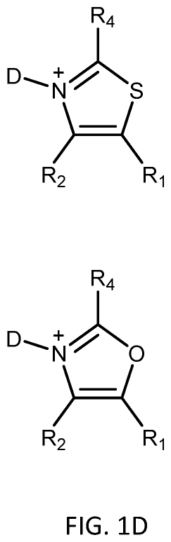

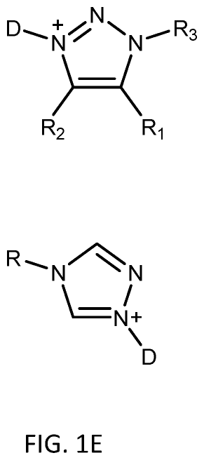

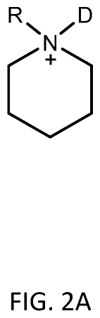

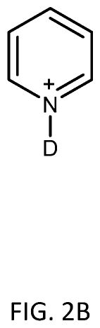

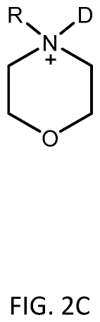

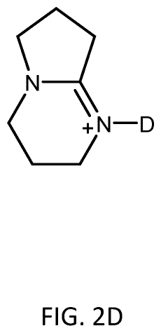

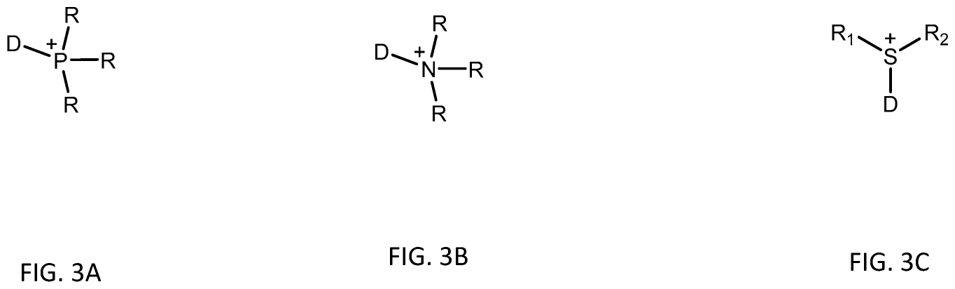

Illustrative diamondoid-functionalized cationic cores are shown in FIGS. 1A-1E to 3A-3C. FIGS. 1A-1E show cationic cores which are nitrogen-containing heterocyclic moieties composed of a 5-membered ring, including pyrrolidine (FIG. 1A), imidazole and benzimidazole (FIG. 1B), pyrazole (FIG. 1C), oxathiole and thiazole (FIG. 1D), and triazole (FIG. 1E). FIGS. 2A-2D show cationic cores which are nitrogen-containing heterocyclic moieties composed of a 6-membered ring, including piperidine (FIG. 2A), pyridine (FIG. 2B), morpholine (FIG. 2C), and 1,5-diazabicyclo[4.3.0]non-5-en (FIG. 2D). FIGS. 3A-3C shows cationic cores which are either a phosphonium moiety (FIG. 3A), an ammonium moiety (FIG. 3B), or a sulfonium moiety (FIG. 3C). In these figures, D may be any of the diamondoid groups described herein and, where present, each R group (i.e., R or each of R₁-R₄) is independently selected from hydrogen, an alkyl group, an aryl group, an alkoxy group (—OR′), an amine group (—NR″₃), and another diamondoid group. However, in embodiments, D is a diamondoid group other than an adamantane group and, where present, each R group (i.e., R or each of R₁-R₄) is independently selected from hydrogen, an alkyl group, an aryl group, an alkoxy group (—OR′), an amine group (—NR″₃), and another diamondoid group (i.e., adamantane or other diamondoid group).

In embodiments, the diamondoid-functionalized cationic core has Formula I, shown below:

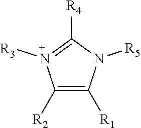

wherein at least one of R₁, R₂, R₃, R₄, and R₅ is a diamondoid group and the remaining of R₁, R₂, R₃, R₄, and R₅ are independently selected from the group consisting of: another diamondoid group, hydrogen, an alkyl group, an aryl group, an alkoxy group, an amine group, and R₁ and R₂ joining to form a fused benzene ring.

In embodiments, the diamondoid-functionalized cationic core has Formula IA, shown below:

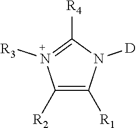

wherein D is the diamondoid group and R₁, R₂, R₃, and R₄ are independently selected from the group consisting of: another diamondoid group, hydrogen, an alkyl group, an aryl group, an alkoxy group, and an amine group. In embodiments of Formula IA, R₁, R₂, R₃, and R₄ are independently selected from the group consisting of: another diamondoid group, hydrogen, and an alkyl group.

In embodiments according to Formula I and IA, the diamondoid group, the alkyl group, the aryl group, the alkoxy group, the amine group may be any of the groups described herein. The diamondoid-functionalized cationic core may be symmetric or non-symmetric as described above.

In embodiments, the diamond-functionalized cationic core is not the quaternary ammonium cation of FIG. 3B, wherein D is adamantane, two R groups are methyl and one R group is a linear alkyl group having from 1 to 12 carbon atoms. In embodiments, the diamond-functionalized cationic core is not 1,3-didiamantylimidazolium. In embodiments, the diamond-functionalized cationic core is not 1,3-triamantylimidazolium. In embodiments, the diamond-functionalized cationic core is not 1,3-ditriamantylimidazolium. In embodiments, the diamond-functionalized cationic core is not 1-adamantyl-3-methylimidazolium. In embodiments, the diamond-functionalized cationic core is not 1-adamantyl-3-butylimidazolium. In embodiments, the diamond-functionalized cationic core is not 1-adamantyl-3-methylbenzimidazolium. In embodiments, the diamond-functionalized cationic core is not 1-adamantyl-3-butylbenzimidazolium.

The present diamondoid salts further comprise a counter anion. A variety of counter anions may be used. Illustrative counter anions include the following: a halide such as Cl⁻, Br⁻, I⁻, F⁻; SCN⁻; [BF₄]⁻; [PF₆]⁻; [SbF₆]⁻; [HSO₃]⁻; [HSO₄]⁻; [CH₃SO₃]⁻; [CH₃OSO₃]⁻; [C₂HsOSO₃]⁻; [CH₃C₆H₄SO₃]⁻; [CF₃SO₃]⁻; [HCF₂CF₂SO₃]⁻; [CF₃HFCCF₂SO₃]⁻; [CHF₂CF₂CF₂SO₃]⁻; [HCClFCF₂SO₃]⁻; [(FSO₂)₂N]⁻; [(CF₃SO₂)₂N]⁻; [(CF₃CF₂SO₂)₂N]⁻; [CF₃OCFHCF₂SO₃]⁻; [CF₂ICF₂OCFHCF₂SO₃]⁻; [CF₃CFHOCF₂CF₂SO₃]⁻; [CF₂HCF₂OCF₂CF₂SO₃]⁻; [CF₂ICF₂OCF₂CF₂SO₃]⁻; [CF₃CF₂OCF₂CF₂SO₃]⁻; [(CF₂HCF₂SO₂)₂N]⁻; [(CF₃CFHCF₂SO₂)₂N]⁻; and [N(CN)₂]⁻.

In embodiments, the counter anion of the diamondoid salt is not I, Br, mesylate, [BF₄]⁻, [PfF₆]⁻, [CF₃SO₃]⁻, [(FSO₂)₂N]⁻, or [(CF₃SO₂)₂N]⁻.

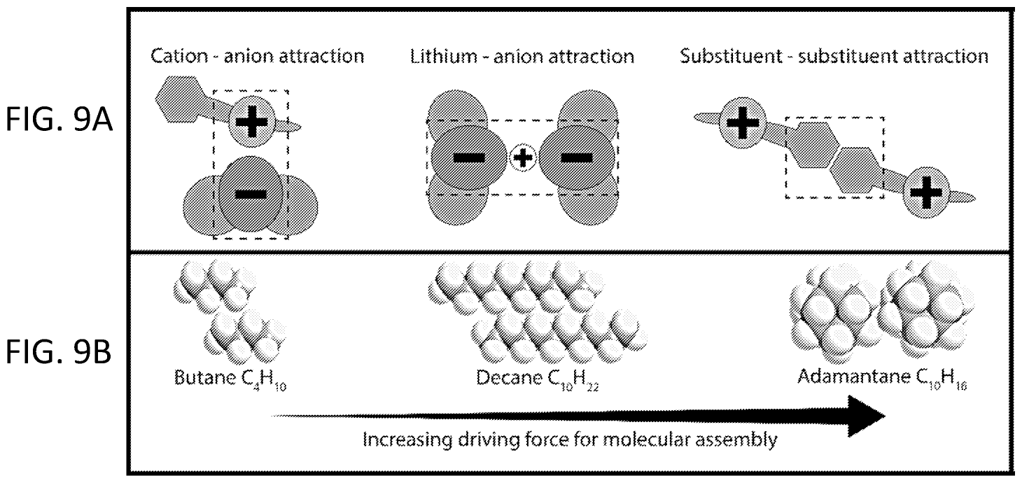

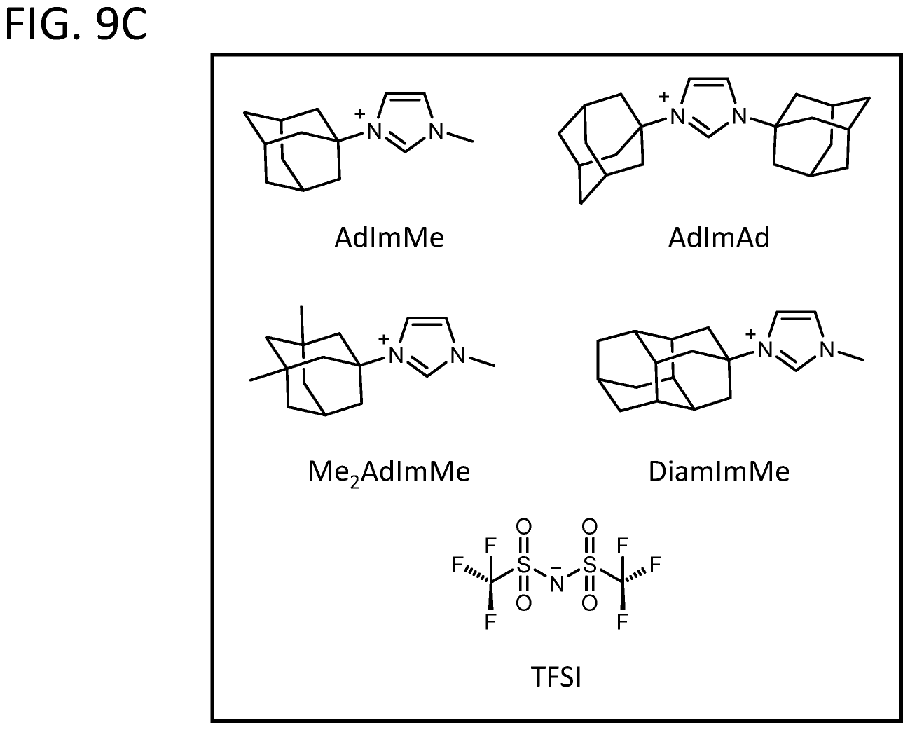

Illustrative diamondoid salts include 3-(adamantan-1-yl)-1-methylimidazolium bromide (may be referred to as “AdImMe Br”), 1,3-bis(adamantan-1-yl)imidazolium (may be referred to as “AdImAd Br”), 3-(diamantan-4-yl)-1-methylimidazolium bromide (may be referred to as “DiamImMe Br”), and 3-(3,5-dimethyladamantan-1-yl)-1-methylimidazolium bromide (may be referred to as “Me₂AdImMe Br”). The structures of the diamondoid-functionalized cationic cores of these salts are shown in FIG. 9C. However, anion metathesis may be used to exchange bromide in any of these diamondoid salts for another counter anion, e.g., bis(trifluoromethylsulfonyl)imide (also shown in FIG. 9C). Any of these diamondoid salts or combinations thereof may be used.

The diamondoid salts may exhibit melting transitions from below room temperature (below: 15° C.) to above 100° C. The diamondoid salts may be liquids or solids at room temperature or at an operating temperature of an electrochemical device incorporating the diamondoid salt. Such electrochemical devices are further described below.

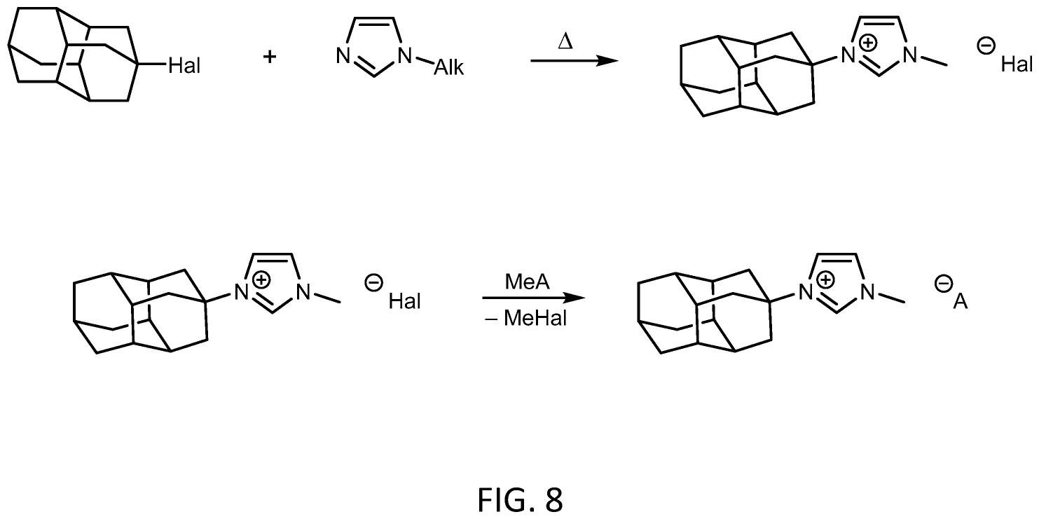

Methods of making the diamondoid salts are also encompassed by the present disclosure. A reaction scheme for synthesizing an illustrative diamondoid salt is shown in FIG. 8. Illustrative experimental conditions for such a reaction scheme are provided in the Example 1, below. This reaction scheme and these conditions may be adjusted to provide other illustrative diamondoid salts by using different diamondoids and different heterocycles (or phosphonium, ammonium, or sulfonium salts) as the starting materials. See also, Richter, Heinrich, et al. Synlett 2009.02 (2009): 193-197, which is hereby incorporated by reference in its entirety.

The present diamondoid salts may be used alone. However, the diamondoid salts may also be combined with other components, e.g., another type of salt, a solvent, and combinations thereof. Regarding salts, these can depend upon the application for the diamondoid salt. However, illustrative salts include organic salts, metallic salts, and combinations thereof. The metallic salts comprise a metal ion, e.g., an alkali metal (Li, Na, etc.), an alkaline earth metal (Ca, Mg, etc.), aluminum, a transition metal, a lanthanide, etc. The counter anion of the metallic salt may be any of those described above with respect to the diamondoid salt. The solvent can also depend upon the application, but illustrative solvents include water and organic solvents such as acetonitrile, dimethyl sulfoxide, propylene carbonate, ethylene carbonate, etc.

The term “electrolyte” may be used in reference to the diamondoid salt alone, since the diamondoid salt itself may be used as an electrolyte in any of the disclosed electrochemical devices. In such embodiments, a single type of diamondoid salt or combinations of different types of diamondoid salts may be used.

However, the term “electrolyte” may be used in reference to the diamondoid salt in combination with another component (e.g., other salt and/or solvent as described above). A single type of each of the diamondoid salt, other salt, and solvent or different types of each may be used. There may be ion exchange with all ions present in such an electrolyte (e.g., cations and anions derived from the diamondoid salt, and if present, the other salt). Such an electrolyte may be a liquid, a solid, or a combination of a liquid and a solid, at room temperature or at an operating temperature of an electrochemical device incorporating the electrolyte. An electrolyte comprising the diamondoid salt and another component may be one that is generally used in any of the electrochemical devices described herein, e.g., a battery or an electrolyzer, in which case the diamondoid salt may be considered to be an additive to such an electrolyte.

In electrolytes comprising the diamondoid salt and another component (e.g., a metallic salt), the diamondoid salt may be present at any suitable amount. In embodiments, the diamondoid salt is used in the electrolyte at a concentration in a range of from 1 μM to 1 M, from 1 μM to 1 mM, or from 1 mM to 1 M. In embodiments, the diamondoid salt is used in the electrolyte at a mole fraction of the diamondoid salt to a metallic salt also present in the electrolyte (e.g., a lithium salt) in a range of from 0.3 to 0.99, 0.4 to 0.95, 0.5 to 0.90, 0.5 to 0.85, or 0.5 to 0.80.

In embodiments, the electrolyte comprises or consists of a diamondoid salt, a metallic salt (e.g., a lithium salt), and optionally, a solvent. Any of the diamondoid salts, metallic salts, and solvents may be used. A single type of each (diamondoid salt, metallic salt, solvent) may be used, or multiple, different types of each.

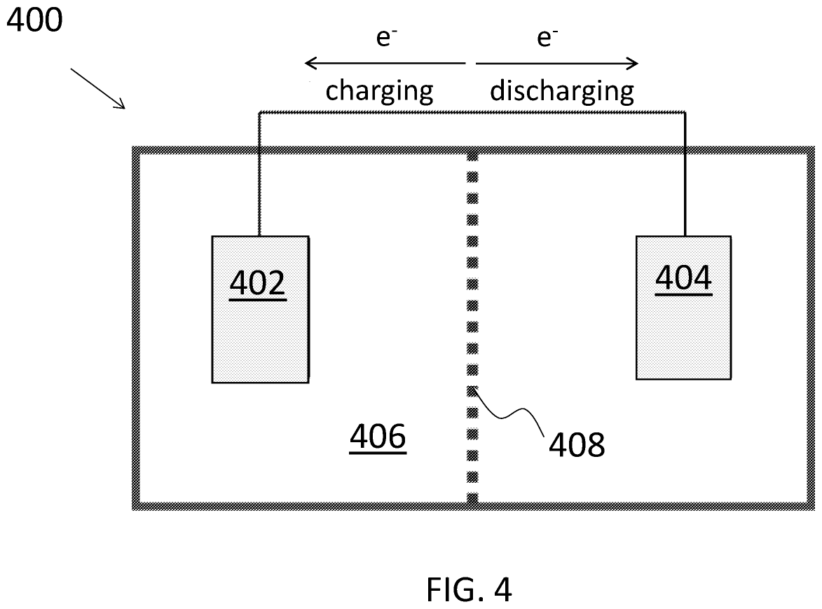

As noted above, the present diamondoid salts and electrolytes may be used in a variety of electrochemical devices. An embodiment of an electrochemical device 400 is shown in FIG. 4, comprising an electrode 402, a counter electrode 404 in electrical communication with the electrode 402, and an electrolyte 406 between the electrode 402 and the counter electrode 404. The electrolyte 406 comprises any of the diamondoid salts described herein. The composition of the electrode 402, the counter electrode 404, and if present, other components of the electrolyte 406 depends upon the type of electrochemical device 400. Similarly, physical aspects such as the positioning of electrodes, the dimensions of electrodes, and the presence of other structural components (e.g., separators such as a separator 408 shown in FIG. 4) also depend upon the type of electrochemical device. In addition, the electrochemical device is not limited to using a single type of electrolyte. More than one type may be present, e.g., a first electrolyte in which the electrode 402 is in contact and a second, different electrolyte in which the second electrode 404 is in contact. In embodiments, the electrochemical device is configured as a battery, such as a lithium-ion battery. In embodiments, the electrochemical device is configured as an electrolyzer, such as a CO₂ electrolyzer. Thus, the electrochemical device may have the physical and chemical attributes generally associated with such devices.

As demonstrated in the Example, below, and noted above, at least some embodiments of the present diamondoid salts are characterized by an ability of the diamondoid-functionalized cationic cores to assemble at a charged interface, e.g., a solid-liquid interface formed between an oppositely charged electrode and an electrolyte comprising the diamondoid salt. This includes assembly to form a layer (or film or coating) of the diamondoid-functionalized cationic cores at such an interface. The layer may reduce or prevent the passage of certain components (e.g., solvent molecules and/or ions) therethrough, while allowing the passage of other components (redox species of interest). Thus, the selectively-permeable layer protects the interface from exposure to these solvent molecules and other ions, which otherwise would reach the interface and decompose. However, as noted above, the present disclosure is not limited to interfacial stabilization via a particular mechanism of stabilization, one example of which is solvent protection via assembly of diamondoid-functionalized cationic cores at an interface.

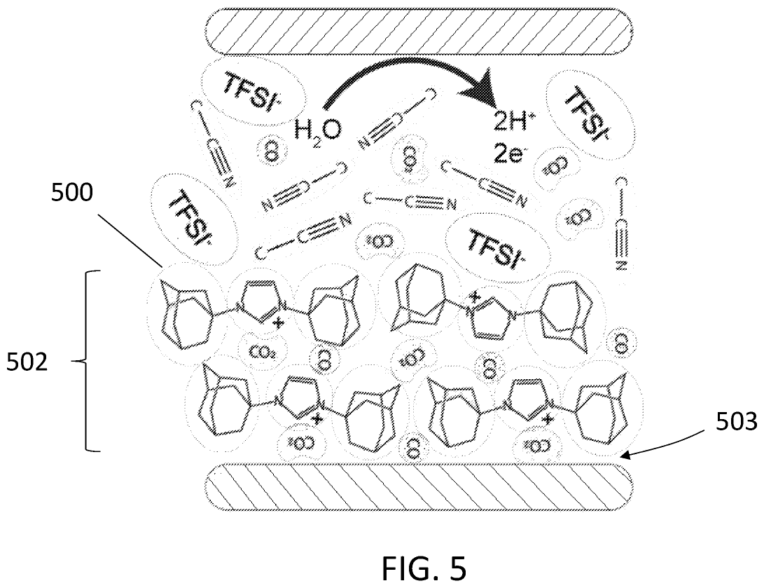

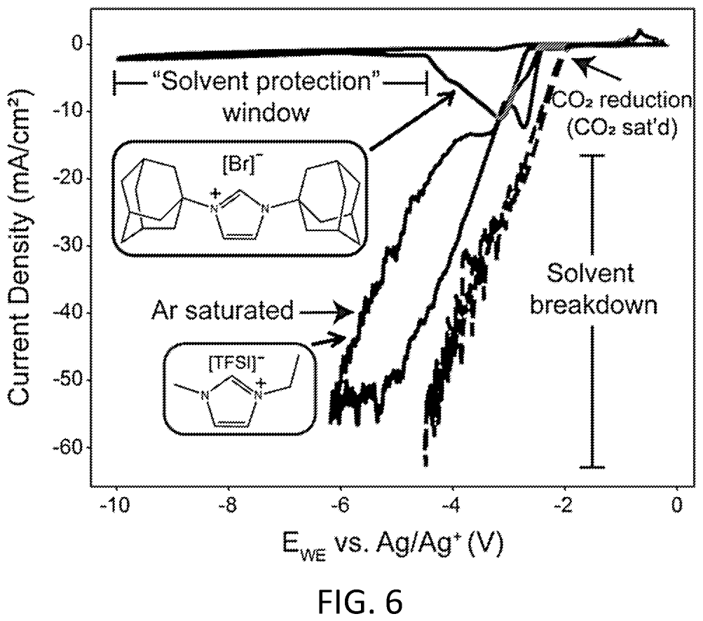

An illustrative stabilization effect of the present diamondoid salts is illustrated in FIG. 5. This figure shows the self-assembly of 1,3-diadamantylimidazolium cations 500 into a layer 502 at a charged interface 503. The layer 502 inhibits the passage of solvent molecules such as acetonitrile and bis(trifluoromethylsulfonyl)imide anions while allowing the passage of CO₂ and CO. This type of interfacial stabilization may be experimentally verified using electrochemical analyses as described in the Examples below. (See also FIG. 6.)

As noted above, another illustrative advantage exhibited by at least some embodiments of the present diamondoid salts relates to increased metal ion (e.g., lithium ion) mobility in mixtures of the diamondoid salt with a metallic salt (e.g., lithium salt). Specifically, when mixed with metallic salts, at least some embodiments of the present diamondoid salts are characterized by an ability to suppress the coordination between metal ions and counter anions, leading to enhanced metal ion mobility in the mixture. This is demonstrated with experimental results described in Example 2, below; e.g., for the diamondoid salt [AdImMe][TFSI].

The present disclosure also encompasses various methods of using the diamondoid salts, electrolytes and electrochemical devices. In embodiments, a method comprises exposing a charged interface to any of the diamondoid salts (or electrolytes comprising the same). As noted above, the diamondoid-functionalized cationic cores of the salts may then assemble into a layer at the charged interface. The methods may be carried out using any of the electrochemical devices described herein and thus, may further comprise steps generally used to operate such devices, e.g., applying an electrical load between electrodes, applying a voltage between electrodes, etc.

### EXAMPLES

### Example 1

A variety of diamondoid salts were prepared. The syntheses of some exemplary diamondoid salts are described as follows. All products were confirmed using NMR spectroscopy.

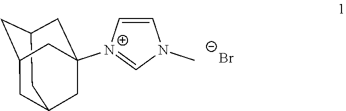 [SMILES: Cn1cc[n+](C23CC4CC(CC(C4)C2)C3)c1 ; [Br-]]

### 3-(adamantan-1-yl)-1-methylimidazolium bromide (1)

Mixture of 1-bromoadamantane (4.30 g, 20 mmol) and 1-methylimidasol (3.28 g, 40 mmol) was heated with stirring in an oil bath at 160° C. for 24 h. Upon cooling to room temperature, the reaction mixture was dissolved in CH₃CN (4 mL) and the resulting solution was poured into Et₂O (100 mL). This mixture was stirred at room temperature for 2 h, after that the solidified product was filtered off and washed on the filter with Et₂O (3×12 mL), then dried in vacuum. This gave 5.41 g (91%) of crude product. Purification. Crude product was dissolved in minimal amount of CH₃OH, this solution was diluted with the same amount of EtOAc and then hot EtOAc was added to the resulting solution bringing CH₃OH: EtOAc ratio to 1:9. The vigorously stirred suspension was cooled to room temperature and the solidified product was filtered off and washed on the filter with 10% CH₃OH in EtOAc. Yield of the 3-(adamantan-1-yl)-1-methylimidazolium bromide was 3.86 g (65%). Colorless crystals, m.p.=230.0-234.1° C.

¹H NMR (400 MHZ, CDCl₃, 25° C.): 8=10.44 (s, 1H), 7.70 (t, J=1.8 Hz, 1H), 7.59 (t, J=1.9 Hz, 1H), 4.21 (s, 3H), 2.31 (bs, 3H), 2.26-2.18 (m, 6H), 1.78 (t, J=3.0 Hz, 6H) ppm.

¹³C NMR (100 MHz, CDCl₃, 25° C.): 8=135.56 (CH), 123.65 (CH), 118.50 (CH), 60.39 (C), 42.78 (CH₂), 36.65 (CH₃), 35.19 (CH₂), 29.31 (CH) ppm.

The diamondoid-functionalized cationic core of Compound 1 is also referred to as “AdImMe,” e.g., in Example 2, below.

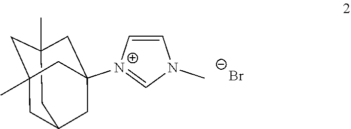

### 3-(3,5-dimethyladamantan-1-yl)-1-methylimidazolium bromide (2)

According to the procedure for 1, from 3,5-dimethyl-1-bromoadamantane (5.20 g, 21.4 mmol) and 1-methylimidasol (3.51 g, 42.8 mmol) 3-(3,5-dimethyladamantan-1-yl)-1-methylimidazole bromide was prepared with 4.25 g (61%) yield. Colorless crystals, m.p.=217.1-219.5° C.

¹H NMR (400 MHZ, CDCl₃, 25° C.): δ=10.50-10.42 (m, 1H), 7.70-7.65 (m, 1H), 7.52-7.48 (m, 1H), 4.20 (s, 3H), 2.42-2.35 (m, 1H), 2.11 (bs, 2H), 1.90-1.78 (m, 4H), 1.46 (AB-system, J_{AB}=12.9 Hz, 1.50 2H_{A}, 1.42 2H_{B}), 1.34-1.23 (m, 2H), 1.00-0.92 (m, 6H) ppm.

¹³C NMR (100 MHZ, CDCl₃, 25° C.): δ=135.78 (CH), 123.71 (CH), 118.44 (CH), 61.99 (C), 49.67 (CH₂), 48.83 (CH₂), 41.66 (CH₂), 41.32 (CH₂), 36.76 (CH₃), 33.13 (C), 30.06 (CH), 29.57 (CH₃) ppm.

The diamondoid-functionalized cationic core of Compound 2 is also referred to as “Me₂AdImMe,” e.g., in Example 2, below.

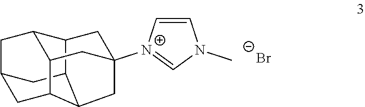 [SMILES: Cn1cc[n+](C23CC4C5CC6CC4C(C2)C(C6)C5C3)c1 ; [Br-]]

### 3-(diamantan-4-yl)-1-methylimidazolium bromide (3)

A mixture of 4-bromodiamantane (4.00 g, 15.0 mmol) and 1-methylimidasol (2.46 g, 30 mmol) was heated with stirring in an oil bath at 160° C. for 3 days. Upon cooling to room temperature, the solid residue was isolated by column chromatography (silica gel, 20% CH₃OH in EtOAc) that gave 2.99 g (57%) of crude product. Pure product was obtained by purification described for 1 yielding 2.20 g (42%) of 3-(diamantan-4-yl)-1-methylimidazole bromide. Colorless crystals, m.p.=256.5-259.8° C.

¹H NMR (400 MHZ, CDCl₃, 25° C.): δ=10.47 (s, 1H), 7.67 (t, J=1.8 Hz, 1H), 7.59 (t, J=1.9 Hz, 1H), 4.20 (s, 3H), 2.23-2.16 (m, 6H), 2.10 (bs, 3H), 1.90-1.83 (m, 4H), 1.82-1.74 (m, 6H) ppm.

¹³C NMR (100 MHz, CDCl₃, 25° C.): δ=135.85 (CH), 123.61 (CH), 118.77 (CH), 59.60 (C), 43.37 (CH₂), 38.25 (CH), 36.71 (CH₂), 36.68 (CH₃), 35.55 (CH), 25.04 (CH) ppm.

The diamondoid-functionalized cationic core of Compound 3 is also referred to as “DiamImMe,” e.g., in Example 2, below.

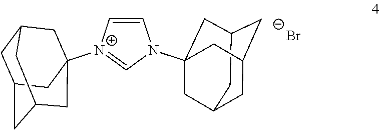 [SMILES: c1c[n+](C23CC4CC(CC(C4)C2)C3)cn1C12CC3CC(CC(C3)C1)C2 ; [Br-]]

### 1,3-bis(adamantan-1-yl)imidazolium bromide (4)

1-aminoadamatane (10.10 g, 66.8 mmol) was dissolved in toluene (18 mL) and this solution was split into two equal portions. To the stirred suspension of paraform (0.97 g, 32.4 mmol) in toluene (10 mL) the following components were added dropwise: first portion of the above prepared solution, then reaction mixture was cooled in the ice bath and second portion was added, then 48% aqueous HBr (2.62 g, 32.4 mmol), ice bath removed and ultimately 40% aqueous solution of glyoxal (1.88 g, 32.4 mmol) was added. The resulting mixture was stirred at 60° C. for 32 h. Upon cooling to room temperature, crystals were filtered off, washed on the filter with toluene (2×10 mL) and dried in air. This gave 12.82 g (92%) of the crude product that was dissolved in CH₃OH. The solvent was slowly evaporated under reduced pressure until it turns into slush, then the crystals were filtered off, and washed on the filter with 20% CH₃OH in EtOAc (2×10 mL). Drying in vacuo yielded 10.04 g (72%) of 1,3-bis(adamantan-1-yl)imidazolium bromide. Colorless crystals, m.p.=327.5-329.9° C.

¹H NMR (400 MHZ, CDCl₃, 25° C.): δ=10.19 (s, 1H), 7.57 (d, J=1.7 Hz, 2H), 2.38-2.33 (m, 12H), 2.33-2.28 (m, 6H), 1.80 (AB-system, J_{AB}=12.6 Hz, 1.84 6H_{A}, 1.76 6H_{B}) ppm.

¹³C NMR (100 MHz, CDCl₃, 25° C.): δ=133.86 (CH), 118.33 (CH), 61.19 (C), 42.90 (CH₂), 35.37 (CH₂), 29.65 (CH) ppm.

The diamondoid-functionalized cationic core of Compound 4 is also referred to as “AdImAd,” e.g., in Example 2, below.

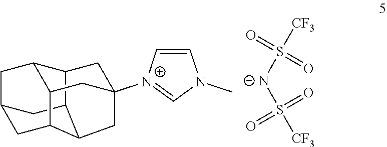 [SMILES: Cn1cc[n+](C23CC4C5CC6CC4C(C2)C(C6)C5C3)c1 ; O=S(=O)([N-]S(=O)(=O)C(F)(F)F)C(F)(F)F]

### 3-(diamantan-4-yl)-1-methylimidazolium bis(trifluoromethane)sulfonimide (5)

To the partially dissolved 3-(diamantan-4-yl)-1-methylimidazole bromide (0.86 g, 2.5 mmol) in H₂O (10 mL), a solution of LiNTf₂ (0.71 g, 2.5 mmol) was added dropwise with stirring at 65° C. During addition solids were dissolved and oily product builds up at the bottom of the flask. The resulting mixture was stirred for 2 h. Upon cooling to room temperature, the aqueous part was separated and the oily product washed with distilled water (3×15 mL). Residual oil was kept under vacuum overnight at 60° C. Yield of the pale yellow 3-(diamantan-4-yl)-1-methylimidazolium bis(trifluoromethane)sulfonimide was 1.28 g (95%). Colorless oil.

¹H NMR (400 MHZ, CDCl₃, 25° C.): δ −8.68 (s, 1H), 7.46 (t, J=1.9 Hz, 1H), 7.36 (t, J=1.8 Hz, 1H), 3.94 (s, 3H), 2.10 (s, 9H), 1.89-1.82 (m, 4H), 1.82-1.76 (m, 6H) ppm.

¹³C NMR (100 MHz, CDCl₃, 25° C.): δ=133.77 (CH), 123.80 (CH), 119.9 (CF, q, J=321.4 Hz), 119.31 (CH), 59.82 (C), 43.16 (CH₂), 38.33 (CH), 36.79 (CH₂), 36.44 (CH₃), 35.65 (CH), 25.13 (CH) ppm.

The diamondoid-functionalized cationic core of Compound 5 is also referred to as “DiamImMe,” e.g., in Example 2, below.

The diamondoid salts were used alone (i.e., pure) or combined with other components to form electrolytes. The electrolytes were prepared by mixing the diamondoid salts with other components (e.g., solvent, other salts) at the desired relative amounts.

The physical properties of the electrolytes, including solubility, thermal stability, phase transition temperatures, viscosity, and density were measured using a combination of accepted characterization techniques, including differential scanning calorimetry (DSC—measurement of phase transition temperatures), thermogravimetric analysis (TGA—measurement of thermal stability), particle-tracking micro-rheology (viscosity), and hydrometer (density). For example, diamondoid salts were observed to be miscible with lithium salts-up to 50 mol % mixtures of lithium bis(trifluorosulfonyl)imide in Compound 5, which is comparable to conventional alkyl-imidazolium analogues of the same species. Phase transition temperatures, densities, and viscosities were seen to be dependent on the structures of diamondoid salts, as well as presence of additional “dopant” species, such as lithium salts, other diamondoid salts, or solvent molecules. Melting transitions ranged from below room temperature (below: 15° C.) to above 100° C., which spans the entire definition of an “ionic liquid,” range, as well as “organic plastic crystal” electrolyte range.

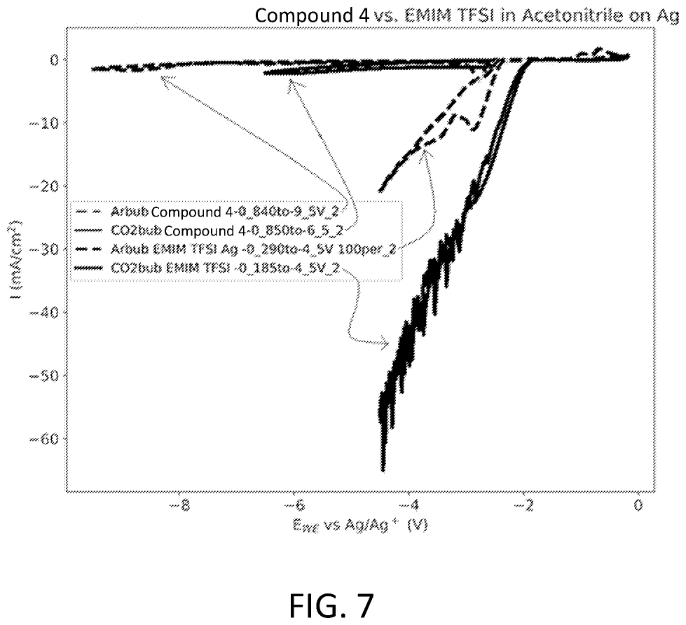

To evaluate electrochemical properties, including stability, electrocatalytic activity, and suitability for battery cycling, a combination of electrochemical analytical methods was performed, including: cyclic voltammetry, electrochemical impedance spectroscopy, chronoamperometry, and cyclic voltammetry. Included representative data was acquired using a platinum counter electrode, a silver/silver nitrate (Ag/AgNO₃) acetonitrile non-aqueous reference electrode, and a variety of working electrodes, which spans a wide-range of standard materials and protocols for electrochemical characterization of ionic liquids and organic plastic crystals. The hardware used was a Biologic potentiostat model SP-300. By performing wide window cyclic voltammetry in inert argon environment on diamondoid salt electrolytes, it was demonstrated that the diamondoid-substituents imbue these salts with remarkable cathodic stability. Representative data is included for 25 mM of Compound 4 in acetonitrile (FIG. 6), and for Compound 3 in acetonitrile (FIG. 7). The data demonstrate that the pronounced “interfacial stabilization” effect persists even at very low diamondoid concentration. To demonstrate the general nature of this effect, the electrochemical stability in the presence of CO₂ was also studied as this is the working state of electrocatalytic reactors.

A representative procedure using acetonitrile as a solvent and Ag as the working electrode was as follows:
1. Measure the concentration of water in acetonitrile using Karl Fischer titration.
   a. Adjust concentration to ˜1000 ppm water in acetonitrile solvent.
2. Add diamondoid salt containing electrolyte to make a defined concentration in a 4-dram scintillation vial.
3. Polish the working electrode using alumina slurry and a polishing pad.
4. Polish the counter electrode and the Ag wire for the reference electrode.
5. Clean the electrode surfaces and sonicate for ˜5 seconds. Dry the counter and Ag wire electrode.
6. Prepare the non-aqueous reference electrode by adding new reference electrolyte consisting of 0.01M AgNO₃ and 0.1M tetrabutylammonium tetrafluoroborate (TBA BF₄) in acetonitrile. Add the silver wire.
7. Assemble the electrochemical cell using a custom-printed electrochemical cap by adding the counter, reference, and working electrodes.
8. Connect the electrodes to the potentiostat in a fume hood.
9. Bubble Ar for 15 minutes.
10. Run Ar trials with Ar passing into the headspace (not active bubbling), which consists of different scan rates between the open circuit potential of the cell and −2.5V vs. Reference (Ref.).
   a. The scan rates include: 100 mV/s, 50 mV/s, 500 mV/s, 1000 mV/s (other scan rates may be used).
   b. Approximately 3 cycles each.
11. Bubble CO₂ for 15 minutes.
12. Run CO₂ trials with CO₂ passing into the headspace (not active bubbling), which consists of different scan rates between the open circuit potential of the cell and −2.5V vs. Ref
   a. The scan rates include: 100 mV/s, 10 mV/s, 50 mV/s, 500 mV/s, 1000 mV/s (other scan rates may be used).
   b. Approximately 3 cycles each.
13. Run the terminal stability/solvent breakdown cycle by scanning from open circuit potential to −10V vs. Ref, reversing the scan when solvent breakdown occurs.
   a. 100 mV/s scan rate, approximately 3 cycles.
14. Detach from the potentiostat and observe changes in electrolyte, as well as electrode surface morphology.
15. Measure water concentration in electrolyte.
16. Save materials for further chemical analysis of any decomposition products in the electrolyte.

Electrolyte decomposition and flammability are major issues facing the development of safe, high power rechargeable lithium-ion and lithium metal batteries, as both factors significantly contribute to catastrophic device failure via thermal runaway and combustion. While alkyl-imidazole ionic liquids show promise for mitigating thermal decomposition and flammability, a critical hurdle for translating imidazolium salts to practical applications is poor electrochemical stability. The results show that attaching diamondoid substituents, including those larger than adamantyl in size, to imidazolium cores directly addresses this critical need. For example, as discussed below, diamondoid substituents such as diamantyl (four additional carbons-next cage) or addition of methyl groups (di-methyladamantyl) exhibit transformative enhancements to electrochemical stability as compared to traditional alkyl-imidazoles. Furthermore, thermal characterization shows that these salts not only recapitulate the non-flammability and high thermal stability of alkyl-imidazolium salts, but actually further enhance these properties.

For example, as shown in FIG. 6 for Compound 4 and in FIG. 7 for Compound 3, the diamondoid salts display a unique “solvent protection” behavior up to approximately −8 to −10 V vs. Ag/AgNO₃. In this “solvent protection” regime, there was no evidence of solvent decomposition, which is typically characterized by visible bubble formation on the electrode surface or very large current densities that extend beyond the electrochemical stability window of the solvent. Rather, the resulting current densities remained below ˜−10 mA/cm² even at very negative potentials. This behavior was observed for the diamondoid salt containing electrolytes in the presence of both Ar and CO₂. It was also observed that this behavior is relatively stable and can be reproduced by cycling the applied potential from the open circuit potential to −10 V vs. Ag/AgNO₃ repeatedly. This result stands in stark contrast to the pronounced cathodic decomposition of traditional alkyl-imidazole analogues under comparable electrochemical potentials and highlights the tremendous stability advantages offered by these diamondoid ionic liquid electrolytes. (See the analogous results for 1-ethyl-3-methylimidazolium bis(trifluoromethylsulfonyl)imide in FIGS. 6 and 7.)

Given the fact that this was observed in multiple classes of diamondoid salt containing electrolytes, including those with at least one diamondoid substituent (including all) having greater than 10 atoms, this effect may originate in the 3-dimensionally constrained nature of relatively large diamondoid substituents.

While imidazolium ionic liquids have been proposed as next-generation CO₂ reduction additives, a current hurdle is the pronounced decomposition of cation promoters under the larger bias needed to achieve practical current densities, exceeding 10 mA/cm². Hence, the pronounced stabilizing effect of diamondoid-functionalized cationic cores (including those with diamondoid substituent(s) larger than 10 carbon atoms) offers distinct advantages for the long-term reduction of CO₂ in electrolyzers, by maintaining the stability of the active cation species.

With all cases of diamondoid-functionalized cationic cores having at least one diamondoid substituent larger than 10 carbon atoms, that were examined in various solvents and using various working electrodes, there was a decrease in onset potential for a reductive process when CO₂ was bubbled into the solution when compared to the behavior of the Ar-bubbled trials. This was observed for instances in which Ar had been bubbled prior to CO₂ for a single sample, as well as when a new sample was used for both the Ar and the CO₂ trials, suggesting that bubbling Ar into the system and performing cyclic voltammetry trials did not influence the CO₂-bubbled behavior, further pointing to the stability of the novel diamondoid-functionalized cationic cores. Onset potentials for reductive processes in the presence of both Ar and CO₂ occurred later (at slightly more negative potentials) when compared to imidazolium-based ionic liquids with linear or cyclic substituents. However, comparing the Ar- and the CO₂-trials between diamondoid salt containing electrolytes suggests that CO₂ impacts the reductive behavior.

After electrolysis, the working electrode for diamondoid salt containing electrolytes that show “solvent protection” behavior exhibited the presence of a residual molecular film, which was white/off-white in color and was easily removed via gentle polishing and rinsing. This film appeared after reaching extremely large negative potentials, which exceeded electrochemical windows needed for either rechargeable batteries or CO₂ electrochemical reduction processes (approximately −5 to −7 V vs. Ag/AgNO₃). Notably, this effect has not been observed for linear alkane-substituted diamond salts, nor for adamantyl-only substituted salts. This may indicate that the presence of these larger diamondoid clusters imbues the cations with new modalities of self-assembling into surface-protecting films. This behavior was observed for a variety of these type of diamondoid salt containing electrolytes and is likely not tied to a specific working electrode or solvent.

### Example 2

As large-scale lithium-ion battery deployment accelerates, battery fires are a growing safety concern. Ionic liquid-derived electrolytes could offer safe, nonflammable alternatives to carbonate electrolytes, but the use of ionic liquids in batteries has long been hindered by poor lithium transport, due to formation of long-lived lithium-anion complexes. This Example reports the design, synthesis, and characterization of a novel class of ionic liquid-inspired organic electrolytes that leverage unique self-assembly properties of molecular diamond templates, called “diamondoids.” By combining thermodynamic characterization with vibrational and magnetic spectroscopy, it was determined that the diamondoid-functionalized cations can facilitate formation of “molecularly porous” phases that resist restructuring upon dissolution of lithium salts. These electrolytes can dramatically suppress lithium-anion coordination, manifesting in substantially enhanced lithium-ion mobility in the organic ion matrix. The results provide a new paradigm for enhancing lithium mobility in solid electrolytes by tuning self-assembly to enhance organic cation-anion interactions, suppress lithium-anion coordination, and increase lithium mobility for safer battery electrolytes.

### INTRODUCTION

Continued improvements to the performance of batteries, capacitors, redox flow cells, and other electrochemical energy storage devices will play a key role in accelerating worldwide transition away from fossil fuels to renewable energy sources. One core challenge associated with the use of intermittent energy sources is a dearth of grid-scale devices and systems that can store and deliver energy under the various timescales needed to match the ability of fossil fuels to deliver reliable, on-demand electricity. Achieving an electricity grid based predominantly on renewable energy will require innovations in multiple areas of energy storage devices, as batteries, capacitors, and redox flow cells are all expected to fill key niches in meeting varying power and lifetime demands, whether for personal use in electric vehicles or for powering entire cities.

One of the drawbacks associated with expanding the use of batteries is that the current generation of devices exhibits poor device safety and lifetime compared to grid needs. Modern batteries not only rely upon reactive, and increasingly scarce, lithium, but also use flammable organic solvents as the major component of electrolytes that transport lithium ions between battery electrodes. This combination of materials leads to an unacceptable level of fire risk in scenarios where incumbent lithium-ion batteries could be deployed at grid scale.

Ionic liquids, organic ionic plastic crystals, and other pure salts are promising electrolytes for use in large-scale energy storage. The low flammability and large electrochemical stability window of these compounds make them attractive alternatives to organic solvents. Despite these features, neither liquid nor solid organic salt-derived electrolytes have exhibited performance that is competitive enough with incumbent electrolytes to merit inclusion in next-generation batteries.

Extensive research into the use of organic salts as battery electrolytes over recent decades has revealed poor selectivity of lithium transport in organic salts as a key barrier hindering translation to devices. In particular, studies increasingly show that most of the current induced across traditional ionic liquid-derived lithium-ion battery electrolytes originates from the higher mobility organic cations, as opposed to the lithium ions that are the redox active species that power devices.

Without wishing to be bound to a particular theory, it is proposed that the high viscosity of ionic liquids (often cited as a primary reason for the limited performance of ionic liquid-derived electrolytes) is not actually the key limiting factor hindering lithium transport in organic salt electrolytes. While highly viscous solutions will hinder hydrodynamic ion motion, it is proposed that much of the poor performance of ionic liquid derived electrolytes may originate from excessive mobility of organic cations relative to lithium, meaning poor lithium transference, rather than from unacceptably low hydrodynamic mobility of lithium.

In this Example, the hypothesis that limiting the mobility of organic ions while concurrently enhancing lithium-ion mobility via self-assembly was examined. Achieving this requires suppression of lithium coordination complexes. Lithium cations have strong affinity to anions in ionic liquids, resulting in the formation of dynamic ion complexes with net negative charges taking the form [Li(Anion)ₓ]^{(1-x)}.

This Example shows that use of molecular diamond templates, called diamondoids, as cation substituents can template solid electrolytes that exhibit remarkable suppression of lithium-anion coordination and concurrent enhancement of lithium mobility. Diamondoids exhibit distinct self-assembling properties, as they are sterically bulky hydrocarbons that are constrained to a single conformer by covalent bonds. As a result, diamondoids can assemble into molecular contact without paying conformational energy penalties associated with the assembly of the flexible linear alkanes that are often used as ionic liquid cation substituents. A lack of entropic penalty for assembly doubles the strength of contact interaction forces between diamondoid pairs as compared to linear alkanes. (See FIGS. 9A-9C.)

This Example reports the synthesis and characterization of the properties of 1-D-3-methylimidazolium bis(trifluoromethanesulfonyl)imide (TFSI) salts with diamondoid substituents that were mixed with [Li][TFSI] as a novel class of solid lithium conductors (“D” refers to the diamondoid substituent). (See FIG. 9C.) In addition to the unique materials properties discussed above, diamondoids are naturally occurring products in oil reserves and are currently treated as waste byproducts. Hence, demonstration of diamondoid-derived electrolytes also promises to valorize a petroleum recovery byproduct that is obtained at large scales. The TFSI anion was chosen as an anion of strong interest for the energy storage community, high electrochemical stability, and strong Raman scattering propensity.

### Materials and Methods

Bromide salts with the diamondoid-functionalized cationic cores shown in FIG. 9C were synthesized as described in Example 1, above. See Compound 1 for AdImMe Br; Compound 2 for Me₂AdImMe Br: Compound 3 for DiamImMe Br; and Compound 4 for AdImAd Br. Next, anion exchange metathesis of bromide with bis(trifluoromethanesulfonyl)imide (TFSI) was performed by dissolving the diamondoid-imidazolium bromide salt in excess water and combining the resulting solution with an equimolar amount of [Li][TFSI], also dissolved in water. (Also, see Compound 5 in Example 1 above). Upon combination, a white powder precipitated from the solution. The precipitate was filtered, washed with water, and dried under vacuum. The dried product was the diamondoid-imidazolium TFSI salt.

The ionic liquids 1-butyl-3-methylimidazolium TFSI ([C₄MIm][TFSI]), 1-decyl-3-methylimidazolium TFSI ([C₁₀MIm][TFSI]), and 1-tetradecyl-3-methylimidazolium TFSI ([C₁₄MIm][TFSI]) were purchased from IoLiTec. Before use, the salts were purified via a protocol of diluting the salt in ethyl acetate, stirring the salt and ethyl acetate solution with activated carbon for two days, filtering the activated carbon out of the solution, and running the ethyl acetate and salt solution through an alumina oxide column with an ethyl acetate mobile phase. Excess solvent was removed using a rotary evaporator. The salts were then dried at 100° C. under vacuum for at least two days. After drying, ionic liquids were hermetically sealed and moved to a nitrogen glove box. Post this purification process, all ionic liquids were clear, colorless liquids.

[Li][TFSI] and organic salt mixtures were melted together under vacuum at 100° C. The melting point of [DiamImMe][TFSI] and [AdImAd][TFSI] exceeded 100° C., so mixtures with those salts were melted and dried at 150° C. Heating was avoided above 150° C. as [Li][TFSI] is reported to undergo an oxidation reaction at temperatures approaching the melting point of pure [Li][TFSI]. After two days, samples were moved to a nitrogen glove box. Water and oxygen levels in the glovebox were monitored to be less than 0.5 ppm.

After melting, mixtures required several days, and sometime multiple weeks, to solidify. Melts with greater [Li][TFSI] mole fractions took longer to solidify. It was found that stirring the melts can induce nucleation and crystallization. All mixtures were found to be glass formers, and samples may form clear, glassy materials instead of white, crystalline phases. When glasses were formed, samples were melted again and slowly cooled. Mixtures containing linear substituents, [C₄MIm][TFSI], [C₁₀ImMe][TFSI], and [C₁₄MIm][TFSI], remained liquids at room temperature. It was found that [C₁₄MImMe][TFSI] mixtures solidify into an amorphous solid at −15° C. Equimolar compositions of [Me₂AdImMe][TFSI] and [Li][TFSI] also remain liquid at room temperature.

### Procedures

Differential scanning calorimetry (DSC) was performed using a TA instruments Q100. Samples were sealed in hermetic pans inside of a glovebox. [AdImMe][TFSI], [Me₂AdImMe][TFSI], [DiamImMe][TFSI], and [AdImAd][TFSI] samples were equilibrated at −50° C., held at that temperature for three minutes, and then heated to 250° C. at a rate of 2° C. per minute. [C₁₄MIm][TFSI] samples were cooled at a rate of 1° C. per minute to −50° C., held at that temperature for three minutes, and then heated to 250° C. at 2° C. per minute. The [C₄MIm][TFSI] and [C₁₀ImMe][TFSI] samples were equilibrated at −50° C. for three minutes and then heated to 250° C. at a rate of 10° C. per minute. Since no phase change was present, these faster scans were performed to look for the dissolving of [Li][TFSI].

Raman spectra were taken on a LabRAM HR Evolution Horiba microscope using a 532 nm laser and grating of 1800 gr/mm. All Raman spectra were fitted and processed using Horiba's LabSpec6 software. Samples were sealed in glass slides inside of a nitrogen glove box using paraffin wax before spectra were taken.

All NMR measurements were carried out at 11.7 T using a broad band two channel 4 mm standard-bore cross-polarization magic-angle spinning (CP MAS) probe on a Bruker Avance III spectrometer with a proton radio frequency of 500.22 MHz, a ¹³C radio frequency of 125.76 MHZ, a ¹⁹F radio frequency 470.66 MHz, and a ⁷Li radio frequency 194.40 MHz. The MAS rate was 10 KHz for the CP and ¹⁹F experiments, and static for the ⁷Li experiments. 4 mm zirconium rotors with Torlon caps and Viton O-rings were used. Approximately 100 mg of samples was packed into each rotor. All samples were prepared and sealed in a nitrogen glove box. The spinning axis was calibrated to the magic angle using KBr.

¹³C spectra were secondary referenced to the up field adamantane peak at 28.7 ppm referenced to TMS. ¹³C CP/MAS NMR spectra were acquired using 1H and ¹³C 90° pulse lengths of 2.5 and 3.5 μs, respectively. Spectra shown represent 1024 signal averages with a 0.05 second acquisition time and a 3 second recycle delay between scans. Cross-polarization radiofrequency strength was 81.4 kHz (maximum) during cross-polarization with a 70-100% ramp and a contact time of 2500 μs. The decoupler radiofrequency was 100 KHz during acquisition.

¹⁹F MAS NMR spectra were acquired using the same instrumentation used for ¹³C NMR. Protocols and pulse sequences were modified to enhance cross-polarization of ¹⁹F nuclei. Spectra shown represent 64 signal average with a 0.05 second acquisition time and a 5 second recycle delay between scans.

⁷Li NMR spectra were acquired using MHz the same instrumentation used for ¹³C NMR. Protocols and pulse sequences were modified to enhance cross-polarization of ⁷Li nuclei. Spectra shown represent 16 signal averages with a 0.05 second acquisition time and a 256 second recycle delay between scans. A pulse length of 2 μs was used to maintain a flip angle of less than π/6.

### Results and Discussion

### Phase Characterization

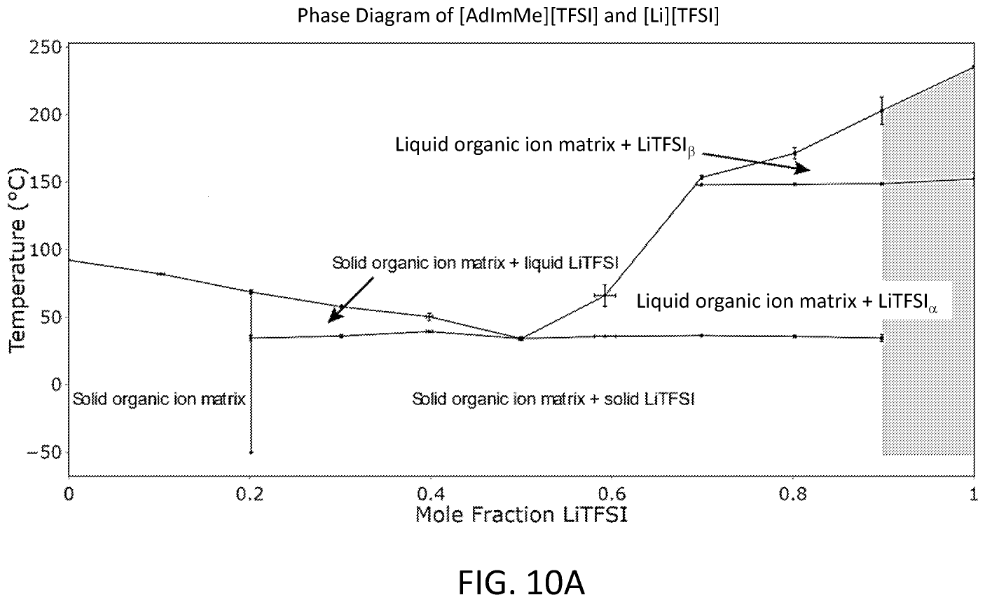

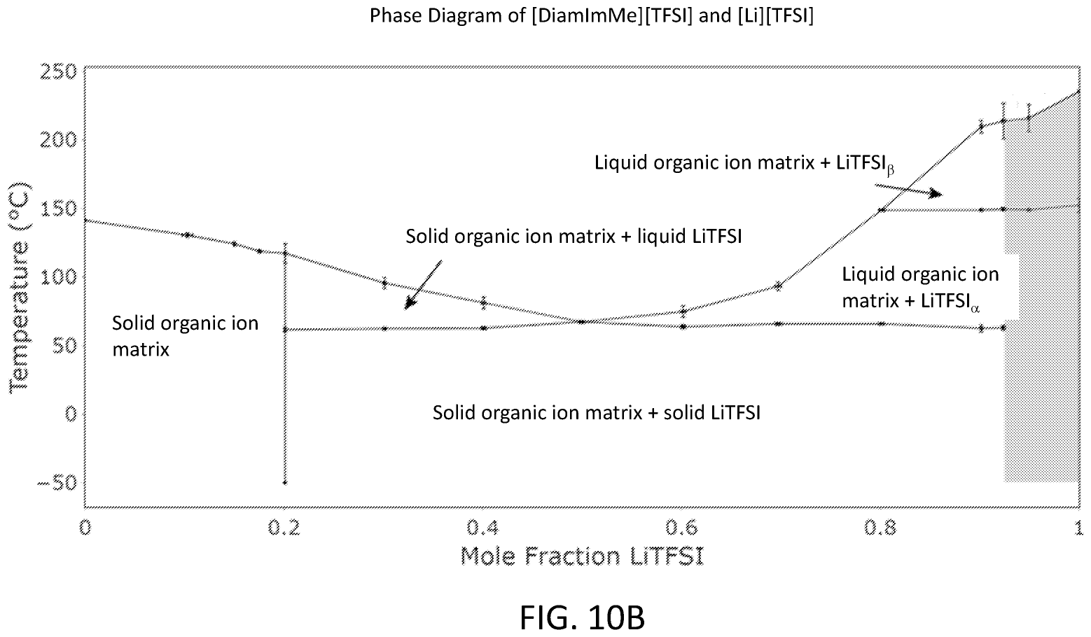

This Example reports phase diagrams of [AdImMe][TFSI] with [Li][TFSI] (FIG. 10A) and [DiamImMe][TFSI] (FIG. 10B) with [Li][TFSI] spanning the full composition space from neat organic salts to pure lithium salts. Both systems exhibited a miscibility gap beginning at a composition of 0.2 mol fraction [Li][TFSI], indicating that the solid solution of lithium in organic salt spans from 0 to 0.2 mole fraction of lithium. This single phase was tacky and putty-like in the mixtures containing [AdImMe][TFSI], but more crystalline in the [DiamImMe][TFSI] containing mixtures. As the lithium concentration was further increased beyond 0.2 mole fraction, the system became biphasic, likely a mixture of the previous organic ion matrix and [Li][TFSI] salt. Upon entering the lithium-rich portion of the composition space, it was found that solid [Li][TFSI] began to precipitate and dissolved into the organic ion matrix upon heating.

The eutectic composition occurring near 0.5 mol fraction [Li][TFSI] is another key similarity between [AdImMe][TFSI] and [DiamImMe][TFSI]. Similar phase behavior was observed for [Li][TFSI] mixed with [AdImAd][TFSI] and [Me₂AdImMe][TFSI]. Equimolar eutectic compositions can take days or weeks to solidify, and these materials also readily form glassy or plastic phases instead of crystals. Controlled cooling of the salt blends is required to facilitate crystal formation.

A phase transition at 0.2 mole fraction [Li][TFSI] has been reported in [EMIm][TFSI] via Raman spectroscopy. (Lassegues, J. C. et al., J Phys Chem A 113, 305-314, doi: 10.1021/jp806124w (2009).) In the [AdImMe][TFSI] and [DiamImMe][TFSI] mixtures with [Li][TFSI], a transition from single phase solid to a binary phase solid was observed at 0.2 mole fraction. It is hypothesized that this transition at 0.2 mole fraction [Li][TFSI] is common among all imidazolium-based salts with the TFSI anion. The combination of cation center and anion determines the solubility of other salts. This has been reported for a variety of alkyl functionalities as well as PEO like functionalities. (Nurnberg, P. et al. J Am Chem Soc 144, 4657-4666, doi: 10.1021/jacs.2c00818 (2022).) Pyrrolidinium TFSI salts differ from their imidazolium TFSI counterparts and form single phases at 0.33 and 0.66 mole fraction [Li][TFSI]. (Zhou, Q. et al. Chem Mater 23, 4331-4337, doi: 10.1021/cm201427k (2011).) This Example shows that the functionality attached to the imidazolium ring did not impact phase behavior outside of the temperature dependent solubility and transition temperatures.

### Raman

Raman spectroscopy was performed to probe the degree of coordination between TFSI anions and lithium ions in diamondoid-derived organic electrolytes. TFSI has strong Raman activity ca. 742 cm⁻¹ in alkyl functionalized ionic liquids and has a strong Raman mode at ca. 747 cm⁻¹ in pure [Li][TFSI]. This peak was assigned to either the CF₃ group or the entire ion stretching, with changes to the wavenumber of this peak indicating differences in coordination environments surrounding the TFSI anion.

As [Li][TFSI] is dissolved in imidazolium TFSI ionic liquids, shifts in the location and magnitude of TFSI peaks is an accepted method for evaluating the degree to which lithium is coordinated to TFSI, versus “free” within the ionic liquid network. If a complex between lithium and TFSI is formed, a new Raman peak ca. 747-750 cm⁻¹ should be observed, and the ratio of the area of these two peaks is believed to represent how many TFSI molecules are coordinated to lithium on average. DFT calculations show that the most energetically favorable coordination structure is [LiTFSI₂]⁻¹ with the TFSI anions adopting a cis conformation in solution.

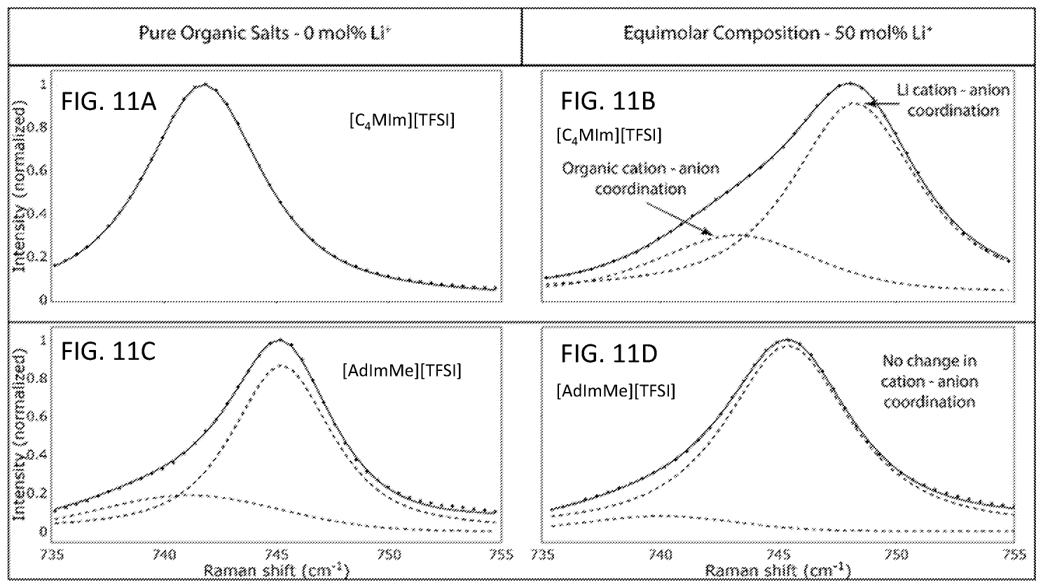

While the ca. 742 cm⁻¹ peak is a mode associated with the TFSI anion, the location of this peak is impacted by the degree of coordination with surrounding imidazolium cations. Hence, Raman spectroscopy was conducted on neat [C₄MIm][TFSI], [C₁₀ImMe][TFSI], and [C₁₄ImMe][TFSI] to determine how the size of linear alkyl substituents influenced imidazolium-TFSI coordination. As demonstrated for [C₄MIm][TFSI] in FIG. 11A, all three salts ([C₄MIm][TFSI], [C₁₀ImMe][TFSI], and [C₁₄ImMe][TFSI]) had Raman activity ca. 742 cm⁻¹, indicating an unchanged or similar electronic environment for TFSI independent of the linear alkyl substituent present on the organic cation.

Raman spectroscopy of the diamondoid salts with rigid functionalities showed pronounced changes to the TFSI stretching mode. As imidazolium-TFSI coordination increases, the Raman mode will shift to higher wavenumbers. As demonstrated for [AdImAd][TFSI] in FIG. 11C, it was found that the lowest energy TFSI Raman mode for the diamondoid salts corresponded to [AdImAd][TFSI] with the Raman shift ca. 740 cm⁻¹, and the highest energy version of this Raman mode corresponded to [AdImMe][TFSI] with a Raman shift ca. 745 cm⁻¹. All values are tabulated in Table 1, below.

TABLE 1
TFSI Raman shifts for various cations.

| | TFSI Raman shift |
|---|---|
| Cation | (cm⁻¹) |
| AdImAd | 740 |
| Me₂AdImMe | 741 |
| BMIm | 742 |
| C₁₀MIm | 742 |
| C₁₄MIm | 742 |
| DiamImMe | 743 |
| AdImMe | 745 |
| Li | 747 |

Lithium coordination to TFSI anions in the mixed salts was strongly correlated with the degree of imidazolium-TFSI coordination measured for the pure organic salts. For equimolar mixtures of [Li][TFSI] and [C₄MIm][TFSI] the Raman spectrum shown in FIG. 11B shows two overlapping peaks. The relative ratio of these peaks can be used to estimate the relative amount of weakly-to-strongly coordinated lithium. This result is consistent with all prior Raman studies of ionic liquid-lithium salt mixtures, where the addition of lithium to form a solid or liquid solution substantially modified the coordination environment of TFSI anions. Such an effect is often interpreted as spectroscopic evidence of strong lithium coordination, which may be the origin of the poor lithium transport behavior exhibited by traditional imidazolium ionic liquids.

As shown in FIG. 11D, remarkably, it was found that an equimolar mixture of [AdImMe][TFSI] and [Li][TFSI] showed no statistical change in the Raman spectra. This unprecedented and unexpected result indicates that Li-TFSI complexation has been severely limited in the [AdImMe][TFSI] system—a longstanding and previously unmet goal in the field of ionic liquid design. The results suggest that [AdImMe][TFSI] is able to effectively eliminate the solvation of lithium ions by TFSI.

In contrast, it was found that [AdImAd][TFSI] exhibits the opposite behavior as compared to [AdImMe][TFSI]. The neat salt TFSI stretching Raman mode was essentially eliminated and the lithium coordination peak was far larger when an equimolar mixture of [AdImAd][TFSI] and [Li][TFSI] was analyzed. It was observed that the neat salt Raman measurements are predictive of the degree of coordination. Salts with lower wavenumber TFSI Raman shifts showed greater lithium coordination when mixed with [Li][TFSI]. Hence, these findings show that certain diamondoid salts exhibit a surprising ability to suppress lithium-TFSI coordination.

### NMR Spectroscopy of Coordination Environments

A combination of ¹³C, ¹⁹F, and ⁷Li NMR was performed to provide a holistic understanding of how the presence of diamondoid substituents influences organic cation interactions, TFSI interactions, and lithium mobility in salt blends. Building on the results described above, complementary NMR studies were conducted to evaluate [AdImMe][TFSI], [DiamImMe][TFSI], and [AdImAd][TFSI] electrolytes as [Li][TFSI] concentration increased.

In all cases, the ¹³C pulse sequence was cross polarized by 1H to amplify the ¹³C signal. Since TFSI does not contain H atoms, anion carbon environments were not amplified and are indistinguishable from noise in the ¹³C spectra. Thus, the ¹³C spectra only show the carbon environments of the cations. Critically, the carbon environments in [AdImMe][TFSI] samples did not experience different chemical shifts, regardless of [Li][TFSI] concentration. This is consistent with the Raman results showing that the cation-anion complex did not change with lithium addition (see FIG. 11D).

The ¹⁹F spectra of [AdImMe][TFSI] mixtures with [Li][TFSI] showed two noticeable features. First, two peaks were observed. Based on previous studies with metal TFSI salts, these were likely representative of different TFSI conformers. The up-field peak corresponded to the trans conformer and the down-field peak corresponded to the cis conformer. Second, in contrast to the ¹³C spectra, the ¹⁹F spectra of [AdImMe][TFSI] changed with addition of [Li][TFSI]. Specifically, a third peak developed, becoming distinct at the eutectic composition. This suggests that despite the Raman results which indicated limited or no change in coordination as lithium concentration increased, lithium and TFSI do appear to be interacting in the [AdImMe][TFSI] and [Li][TFSI] mixtures.

### NMR Spectroscopy of Lithium Dynamics

Taken together, the Raman spectroscopy and ¹³C, ¹⁹F NMR results show that the addition of diamondoid substituents to imidazolium cations can dramatically suppress the formation of Li-TFSI coordination under certain conditions. To evaluate the hypothesis that suppression of lithium coordination and incorporation of rigid molecular species can mobilize lithium, solid state NMR spectroscopy of ⁷Li was performed to evaluate changes in lithium linewidths as a means of measuring changes in lithium mobility. Static ⁷Li NMR spectra indicate the degree of chemical shift anisotropy that the lithium atoms experienced in each salt mixture. A broader peak indicates that the orientation of the bulk structure had greater impact on the magnetic moment experienced by the lithium atom. If the magnetic moment is dependent on the crystallographic orientation, then the lithium is more heavily interacting with the surrounding atoms.

Notably, all salts in mixtures greater than 0.2 mol fraction [Li][TFSI] exhibited the same lithium spectra. Specifically, all the lithium spectra had full-width-half-max peak measurements of approximately 3100 Hz and the peak and linewidth were indistinguishable from pure [Li][TFSI]. Hence, it was found that the portion of the phase space that induces [Li][TFSI] formation results in low mobility, although Raman results suggest that lithium cations are completely uncoordinated with TFSI.

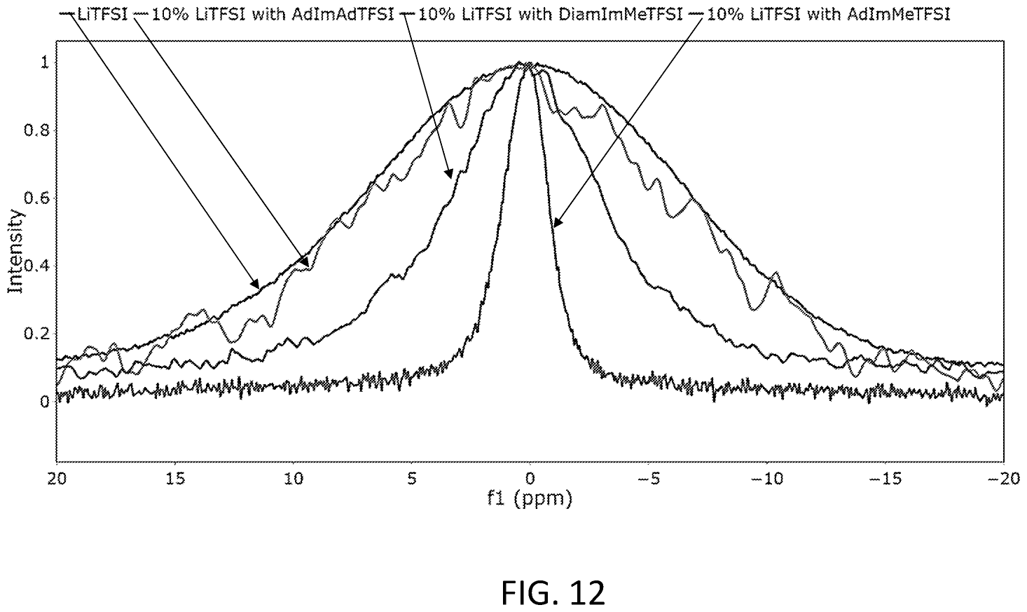

However, in the single-phase solid solution phase (mixtures less than 0.2 mol fraction [Li][TFSI]), pronounced differences were observed in the peak width as a function of imidazolium substituent, suggesting substantial differences in lithium mobility. This is demonstrated in in FIG. 12 for mixtures, at 0.1 mol fraction lithium. Specifically, it was found that the linewidth of the [AdImAd][TFSI] mixture was slightly narrower than that of pure lithium salt. The [DiamImMe][TFSI] mixture exhibited a significantly narrower line width, indicating enhanced lithium mobility. Remarkably, the [AdImMe][TFSI] mixture exhibited an unexpectedly pronounced narrowing of the linewidth. In fact, the full-width-half-max for the [AdImMe][TFSI] mixture suggests that the mobility of lithium in this electrolyte is on par with that of a known organic ionic plastic crystal, N-ethyl-N-methylpyrrolidinium bis(fluorosulfonyl)imide. (Wang, X. E. et al. Adv Mater Technol-Us 2, doi: ARTN 1700046.) The values for the peak widths of the 0.1 mole fraction [Li][TFSI] mixtures are tabulated in the supplemental information (Table 2).

TABLE 2
Peak widths for various cations.

| Cation | Peak Width (Hz) |
|---|---|
| AdImMe | 454 |
| DiamImMe | 1634 |
| AdImAd | 3159 |

The spectrum for the 0.2 mole fraction mixture of [Li][TFSI] in [AdImMe][TFSI] exhibited two different peaks, indicating a more mobile and a less mobile regime. This splitting at the beginning of the biphasic regime demonstrates that organic crystal lattice impacts mobility. As noted above, the [AdImMe][TFSI] sample with 0.1 mole fraction [Li][TFSI] exhibited the greatest lithium mobility of all samples tested. This aligns with the Raman and the ¹³C NMR results. Moreover, results showed that the 0.1 mole fraction [Li][TFSI] in [AdImMe][TFSI] mixture had a 10 percent thinner peak than a 0.1 mole fraction [Li][TFSI] in N-ethyl-N-methylpyrrolidinium bis(fluorosulfonyl)imide mixture. Surprisingly, even though [AdImMe][TFSI] does not have the rotational modes of the organic ionic plastic crystal (N-ethyl-N-methylpyrrolidinium bis(fluorosulfonyl)imide), the diamondoid salt exhibits significantly greater lithium-ion mobility. This shows that the nanostructure of the salt can have a dramatic impact on the mobility of lithium ions. In addition, the 0.1 mole fraction [Li][TFSI] in [AdImMe][TFSI] mixture exhibited plastic behavior, indicating that the physical properties of organic ionic plastic crystals are not necessarily a result of the rotational modes of the ions in the plastic crystal.

### CONCLUSION

By functionalizing imidazolium cations with cage-like hydrocarbon substituents called diamondoids, the nanostructure of salt structures can be modified and modulated to strengthen organic cation-anion interactions. This new ion network is predicated on enhanced pairwise interactions that guide self-assembly and are difficult to interrupt. The introduction of lithium salts does not disrupt the ion network at concentrations below 0.2 mole fraction. Above this mole fraction, lithium-anion interactions become more influential on the salt structure and ion interactions. NMR spectroscopy results indicate that nanostructured diamondoid electrolyte phases can maintain remarkable lithium mobility, suggesting the presence of a solid electrolyte with persistent “molecular porosity” for lithium cations. As an additional advantage, diamondoid clusters are currently generated at ton scales as petroleum waste products, and this Example shows that these unexplored functional groups can create electrolytes that may bridge the gap between traditional flammable liquids and ceramic electrolytes. Finally, since this chemistry is not based upon metal cation interactions with the surrounding structure, it is believed that these systems can be applied to other metal salt systems with solubility being the only limiting factor.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. An electrolyte for an electrochemical device, the electrolyte comprising a metallic salt and a diamondoid salt, the diamondoid salt comprising a diamondoid-functionalized cationic core and a counter anion, the diamondoid-functionalized cationic core comprising a cationic core and a diamondoid group covalently bound to the cationic core.

2. The electrolyte of claim 1, wherein the cationic core is selected from a nitrogen-containing heterocyclic moiety, a phosphonium moiety, an ammonium moiety, and a sulfonium moiety.

3. The electrolyte of claim 2, wherein the nitrogen-containing heterocyclic moiety comprises a 5-membered ring.

4. The electrolyte of claim 3, wherein the 5-membered ring is selected from a group consisting of pyrrolidine, imidazole, benzimidazole, pyrazole, oxathiole, thiazole, and triazole.

5. The electrolyte of claim 2, wherein the nitrogen-containing heterocyclic moiety comprises a 6-membered ring.

6. The electrolyte of claim 5, wherein the 6-membered ring is selected from a group consisting of piperidine, pyridine, morpholine, and 1,5-diazabicyclo[4.3.0]non-5-en.

7. The electrolyte of claim 1, wherein any other position on the cationic core not occupied by the diamondoid group is an R group and each R group is independently selected from a group consisting of hydrogen: an unsubstituted or substituted alkyl group: an unsubstituted or substituted aryl group: an alkoxy group (—OR′) wherein R′ is hydrogen or an unsubstituted alkyl group: an amine group (—NR″₃) wherein each R″ is independently selected from hydrogen and an unsubstituted alkyl group; and a second diamondoid group.

8. The electrolyte of claim 1, wherein the cationic core is selected from a nitrogen-containing heterocyclic moiety and wherein any other position on the cationic core not occupied by the diamondoid group is an R group and each R group is independently selected from a group consisting of hydrogen: an unsubstituted or substituted alkyl group: an unsubstituted or substituted aryl group: an alkoxy group (—OR′) wherein R′ is hydrogen or an unsubstituted alkyl group; an amine group (—NR″₃) wherein each R″ is independently selected from hydrogen and an unsubstituted alkyl group; and a second diamondoid group.

9. The electrolyte of claim 8, wherein the nitrogen-containing heterocyclic moiety comprises a 5-membered ring.

10. The electrolyte of claim 9, wherein the 5-membered ring is imidazole.

11. The electrolyte of claim 1, wherein the diamondoid-functionalized cationic core has Formula I 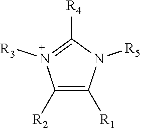
wherein at least one of R₁, R₂, R₃, R₄, and R₅ is the diamondoid group and the remaining of R₁, R₂, R₃, R₄, and R₅ are independently selected from a group consisting of: a second diamondoid group; hydrogen; an unsubstituted or substituted alkyl group; an unsubstituted or substituted aryl group; an alkoxy group (—OR′) wherein R′ is hydrogen or an unsubstituted alkyl group; an amine group (—NR″₃) wherein each R″ is independently selected from hydrogen and an unsubstituted alkyl group; and R₁ and R₂ joining to form a fused benzene ring.

12. The electrolyte of claim 11, wherein the diamondoid-functionalized cationic core has Formula IA 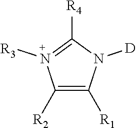
wherein D is the diamondoid group and R₁, R₂, R₃, and R₄ are independently selected from a group consisting of: a second diamondoid group; hydrogen; an unsubstituted or substituted alkyl group: an unsubstituted or substituted aryl group; an alkoxy group (—OR′) wherein R′ is hydrogen or an unsubstituted alkyl group; and an amine group (—NR″₃) wherein each R″ is independently selected from hydrogen and an unsubstituted alkyl group.

13. The electrolyte of claim 12, wherein R₁, R₂, R₃, and R₄ are independently selected from a group consisting of: a second diamondoid group: hydrogen: an unsubstituted alkyl group; and a substituted alkyl group.

14. The electrolyte of claim 1, wherein the diamondoid-functionalized cationic core is 3-(adamantan-1-yl)-1-methylimidazolium: 1,3-bis(adamantan-1-yl)imidazolium; 3-(diamantan-4-yl)-1-methylimidazolium; or 3-(3,5-dimethyladamantan-1-yl)-1-methylimidazolium.

15. The electrolyte of claim 1, wherein the diamondoid-functionalized cationic core is 3-(adamantan-1-yl)-1-methylimidazolium.

16. The electrolyte of claim 1, wherein the diamondoid salt has 1 or 2 diamondoid groups covalently bound to the cationic core.

17. The electrolyte of claim 1, wherein the diamondoid salt is non-symmetric.

18. The electrolyte of claim 1, wherein the diamondoid group is other than adamantane.

19. The electrolyte of claim 1, wherein the metallic salt is lithium salt.

20. An electrochemical device comprising an electrode, a counter electrode in electrical communication with the electrode, and the electrolyte of claim 1 in contact with the electrode, the counter electrode, or both.

21. The electrochemical device of claim 20, wherein the electrochemical device is a lithium-ion battery.

22. The electrochemical device of claim 20, wherein the electrochemical device is a CO₂ electrolyzer.

23. A method of operating the electrochemical device of claim 20, the method comprising applying an electrical load or a voltage between the electrode and the counter electrode.
